(19) United States
(12) Patent Application Publication
(10) Pub. No.: US 2016/0010821 A1
(43) Pub. Date: Jan. 14, 2016

(54) Laser Optical System for Headlamps

(71) Applicants: Hyundai Motor Company, Seoul (KR); SL Lighting Corporation, Daegu (KR)

(72) Inventors: Byoung Suk Ahn, Suwon-Si (KR); Dae Kon Kim, Gyeongsan-Si (KR); Sung Wook Youn, Daegu (KR); Seok Ju Lee, Gyeongsan-Si (KR)

(73) Assignees: Hyundai Motor Company, Seoul (KR); SL Lighting Corporation, Daegu (KR)

(21) Appl. No.: 14/526,783

(22) Filed: Oct. 29, 2014

(30) Foreign Application Priority Data
Jul. 10, 2014 (KR) 10-2014-0086695

(51) Int. Cl. F21S 8/10

(52) U.S. Cl. CPC F21S 48/115; F21S 48/12; F21S 48/13; F21Y 2101/025

(57) ABSTRACT

A laser optical system for headlamps may include a laser diode generating a laser beam, a fluorescent body reacting to the laser beam and outputting white light, a main reflector reflecting the white light output from the fluorescent body forward, an aspheric lens directing the white light reflected by the main reflector forward, and a beam lens provided on a front surface of the fluorescent body. The beam lens may contract the laser beam entering the fluorescent body and reduce a radiation angle of the white light output from the fluorescent body. The laser diode may be configured such that a center axis of the laser diode is aligned with a reference line, the reference line being substantially perpendicular to an incident surface of the fluorescent body and passing through a center or a center portion of the fluorescent body.

### CROSS-REFERENCE TO RELATED APPLICATION

The present application claims priority of Korean Patent Application Number 10-2014-0086695 filed on Jul. 10, 2014, the entire contents of which application are incorporated herein for all purposes by this reference.

### BACKGROUND OF INVENTION

1. Field of Invention

The present invention relates generally to laser optical systems for headlamps and, more particularly, to a laser optical system for headlamps which can minimize optical loss and thus increase optical efficiency, and which has a reduced size so that the degree of freedom in design can be enhanced.

2. Description of Related Art

Headlamps (headlights) for vehicles are lamps for use in lighting the road ahead to ensure the front visibility of a driver. Halogen lamps, HID (high intensity discharge) lamps or LED diodes are typically used as light sources for headlamps.

However, halogen lamps, HID lamps, LED diodes, etc. have a disadvantage of low optical efficiency because of high power consumption. Particularly, because the size of an entire optical system including a light source and a lens is relatively large, there are disadvantages in that the degree of freedom in design is low, and it is also comparatively heavy.

Recently, headlamps have been developed and are becoming increasingly common in which laser diodes, which are environmental-friendly and have a long lifetime and high optical efficiency, are used as light sources.

As shown in FIGS. 1 and 2, a conventional laser optical system for headlamps includes a laser diode 1 which generates a laser beam of a blue wavelength range, a fluorescent body 2 which reacts to light output from the laser diode 1 and outputs white light, a reflector 3 which reflects white light output from the fluorescent body 2 forward, and an aspheric lens 4 which is disposed ahead of the reflector 3, collects and diffuses white light reflected by the reflector 3 and emits the white light forward.

In this conventional laser optical system having the above-mentioned construction, the laser diode 1 is configured such that it is inclined by a predetermined angle with respect to a reference line L1 which is perpendicular to an incident surface 2a of the fluorescent body 2. As such, because the laser diode 1 is installed in such a way that it is inclined by a predetermined angle a1, a diameter a2 of a laser beam entering the fluorescent body 2 is increased. An increase in the diameter a2 of a laser beam increases an exit angle, that is, an effective radiation angle a3, of white light which is output towards the reflector 3 after exiting via the fluorescent body 2. As the effective radiation angle a3 increases, a light loss range a4 in which white light comes out of the reflector 3 also increases. Therefore, the entire optical loss of the optical system is increased, and the optical efficiency thereof is thus reduced.

It is preferable that whole laser beam output from the laser diode 1 can enter the fluorescent body 2 to minimize the optical loss of the laser optical system. Because of this reason, as shown in the conventional technique, if the laser diode 1 is inclined by a predetermined angle a1 and thus the diameter a2 of a laser beam entering the fluorescent body 2 is relatively large, the size a5 of the fluorescent body 2 must also be increased to make it possible to receive the whole laser beam output from the laser diode 1. Therefore, the size of the entire optical system is increased, whereby the weight and the production cost thereof are increased, and the degree of freedom in design is reduced.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Accordingly, the present invention has been made keeping in mind the above problems occurring in the prior art and/or other problems, and an object of the present invention is to provide a laser optical system for headlamps which is configured such that the diameter of a laser beam entering a fluorescent body can be reduced and thus an exit angle, that is, an effective radiation angle, of a laser beam coming out of the fluorescent body towards a reflector after exiting via the fluorescent body can be reduced, whereby optical loss can be minimized, optical efficiency can be enhanced and, particularly, the size of the optical system can be reduced; thus making it possible to reduce the weight and the production cost of the optical system and increase the degree of freedom in design. loom In various aspects, the present invention provides a laser optical system for headlamps, including: a laser diode generating a laser beam; a fluorescent body reacting to the laser beam and outputting white light; a main reflector reflecting the white light output from the fluorescent body forward; an aspheric lens directing the white light reflected by the main reflector forward; and a beam lens provided on a front surface of the fluorescent body, the beam lens contracting the laser beam entering the fluorescent body and reducing a radiation angle of the white light output from the fluorescent body, wherein the laser diode is configured such that a center axis of the laser diode is aligned with a reference line, the reference line being substantially perpendicular to an incident surface of the fluorescent body and passing through a center or a center portion of the fluorescent body.

The diameter of the beam lens may be greater than a diameter of the laser beam entering a lens surface of the beam lens and less than a size of the main reflector. The fluorescent body and the beam lens may be disposed in a space defined by the main reflector, and the laser diode may be disposed outside the main reflector. The beam lens may comprise an aspheric lens or a convex lens.

In various other aspects, the present invention provides a laser optical system for headlamps, including: a laser diode generating a laser beam; a fluorescent body reacting to the laser beam and outputting white light; a main reflector reflecting the white light output from the fluorescent body forward; an aspheric lens directing the white light reflected by the main reflector forward; a beam lens provided on a front surface of the fluorescent body, the beam lens contracting the laser beam entering the fluorescent body and reducing a radiation angle of the white light output from the fluorescent body; and a beam reflector reflecting the laser beam, output from the laser diode, towards the beam lens, wherein a path of the laser beam reflected by the beam reflector is aligned with a reference line, the reference line being substantially perpendicular to an incident surface of the fluorescent body and passing through a center or a center portion of the fluorescent body.

The fluorescent body and the beam lens may be disposed in a space defined by the main reflector, and the laser diode and the beam reflector may be disposed outside the main reflector. The beam reflector may comprise a mirror.

In some other aspects, the present invention provides a laser optical system for headlamps, including: a laser diode generating a laser beam; a fluorescent body reacting to the laser beam and outputting white light; a main reflector reflecting the white light output from the fluorescent body forward; and an aspheric lens directing the white light reflected by the main reflector forward, wherein the laser diode is configured such that a center axis of the laser diode is aligned with a reference line, the reference line being substantially perpendicular to an incident surface of the fluorescent body and passing through a center or a center portion of the fluorescent body.

A laser optical system for headlamps according to the present invention is configured such that a path along which a laser beam output from a laser diode goes is aligned with a reference line which is perpendicular or substantially perpendicular to an incident surface of a fluorescent body and passes through the center or the center portion of the fluorescent body. By virtue of such a configuration, optical loss of the optical system can be minimized, whereby the optical efficiency of the optical system can be markedly enhanced. Furthermore, because the size of the fluorescent body can be greatly reduced, the size, weight and production cost of the optical system can also be reduced, and the degree of freedom in design thereof can be enhanced.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

The above and other objects, features and advantages of the present invention will be more clearly understood from the following detailed description taken in conjunction with the accompanying drawings, in which:

FIG. 1 and FIG. 2 are views illustrating a conventional laser optical system for headlamps;

FIG. 3 and FIG. 4 are views illustrating an exemplary laser optical system for headlamps according to the present invention; and

FIG. 5 is a view illustrating another exemplary laser optical system for headlamps according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

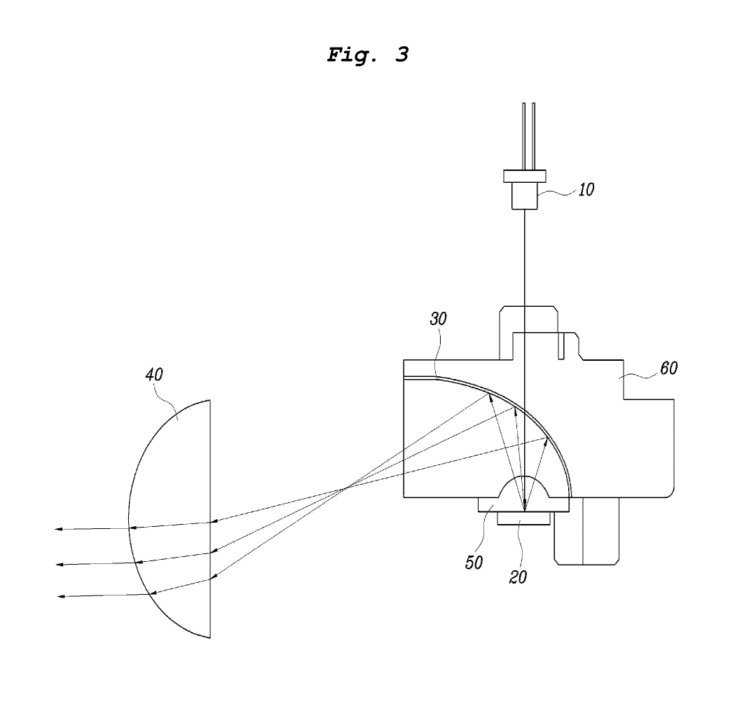

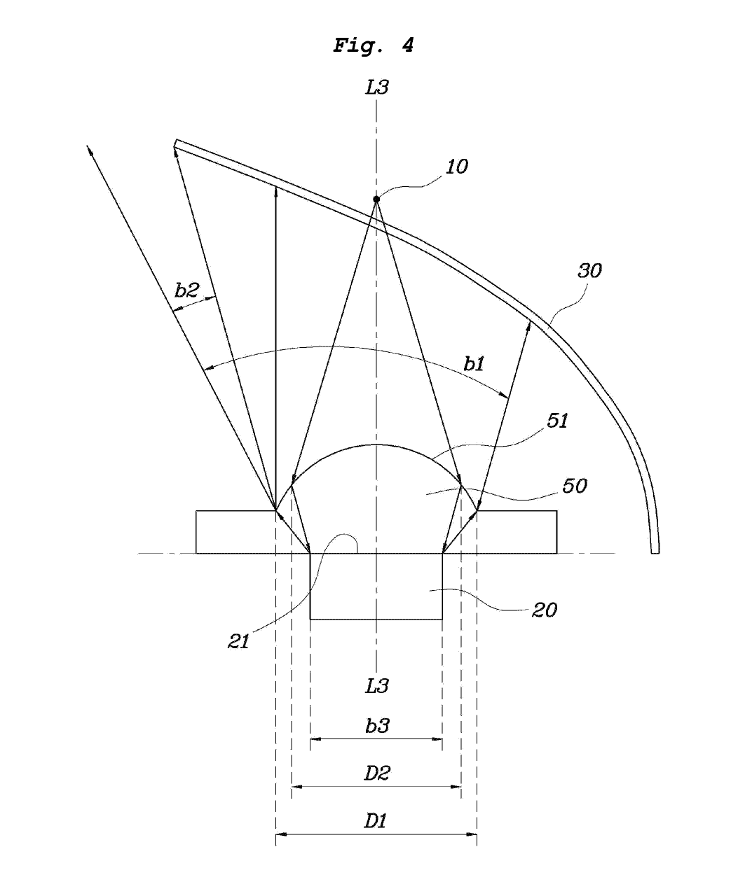

As shown in FIGS. 3 and 4, a laser optical system for headlamps according to various embodiments of the present invention includes: a laser diode 10 which generates a laser beam such as a laser beam of a blue wavelength band (typically, a short-wavelength band of about 450 nm); a fluorescent body 20 which reacts to the laser beam and outputs white light; a main reflector 30 which reflects white light output from the fluorescent body 20 forward; an aspheric lens 40 which is disposed ahead of the main reflector 30, collects and diffuses white light reflected by the main reflector 30 and then directs the white light forward; and a beam lens 50 which is disposed on a front surface of the fluorescent body 20, condenses or contracts a laser beam entering the fluorescent body 20, and reduces a radiation angle of white light output from the fluorescent body 20 after exiting via the fluorescent body 20. The laser diode 10 is configured such that a center axis of the laser diode 10 is aligned with a reference line L3 which is perpendicular to an incident surface 21 of the fluorescent body 20 and passes through the center or the center portion of the fluorescent body 20.

The fluorescent body 20, the main reflector 30 and the beam lens 50 are fixed and installed in a housing 60 of the optical system. The aspheric lens 40 is installed in the housing 60 by a holder and disposed ahead of the main reflector 30. The main reflector 30 has an arc-shaped cross-section. The fluorescent body 20 and the beam lens 50 are disposed in a space defined by the main reflector 30. The laser diode 10 is disposed outside the main reflector 30.

The laser optical system according to the present invention may further include a PCB (printed circuit board) which controls supply of current to the laser diode 10, and a heat sink which dissipates heat from the laser diode 10 and the fluorescent body 20.

Preferably, in some embodiments, a diameter D1 of the beam lens 50 is larger than a diameter D2 of a laser beam which enters a lens surface 51 of the beam lens 50. The reason for this is to make the entirety or substantially the entirety of a laser beam, output from the laser diode 10, enter the beam lens 50 without loss, whereby the optical loss can be reduced while the optical efficiency can be enhanced.

Furthermore, the diameter Dl of the beam lens 50 is preferably less than the size of the main reflector 30. The reason for this is because the center of the beam lens 50 (the center of the fluorescent body) is disposed at the focal point of the main reflector 30 and thus there is no necessity for making the diameter D1 of the beam lens 50 be larger than the focal distance of the main reflector 30.

The beam lens 50 condenses or contracts an incident laser beam and refracts the beam to enable it to enter the fluorescent body 20. In some embodiments, it is preferable that an aspheric lens or a convex lens be used as the beam lens 50 to reduce a radiation angle of white light output from the main reflector after the white light has exited via the fluorescent body 20, but the present invention is not limited to this.

As described above, in the laser optical system according to such embodiments of the present invention, the laser diode 10 is installed such that the center axis of the laser diode 10 is aligned with the reference line L3, which is perpendicular to the incident surface 21 of the fluorescent body 20 and passes through the center of the fluorescent body 20. As such, if the laser diode 10 is provided such that the center axis of the laser

Substitute Specification diode 10 is aligned with the reference line L3, the diameter D2 of a laser beam which enters the lens surface 51 of the beam lens 50 can be markedly reduced compared to that of the conventional technique (a2>D2).

The beam lens 50 according to the present invention condenses or contracts a laser beam which enters the beam lens 50 through the lens surface 51 and then refracts the laser beam to enable the laser beam to enter the fluorescent body 20. By virtue of the beams lens 50, the diameter of a laser beam which enters the fluorescent body 20 can be markedly reduced.

Furthermore, the beam lens 50 also functions to reduce an exit angle, that is, an effective radiation angle b1, of white light when the laser beam that enters the beam lens 50 is output towards the main reflector 30 after exiting via the fluorescent body 20 (a3>b1). As such, if the effective radiation angle b1 is reduced compared to that of the conventional technique, a light loss range b2 in which white light comes out of the main reflector 30 can be markedly reduced. Therefore, the optical loss of the entire optical system can be minimized, and the optical efficiency of the optical system can be markedly enhanced.

In addition, if the effective radiation angle b1 of white light output to the main reflector 30 can be reduced, the quantity of light per a unit area can be increased. Thereby, the brightness of the optical system can be markedly increased.

Moreover, when the laser diode 10 is installed such that the center axis of the laser diode 10 is aligned with the reference line L3, particularly, if the beam lens 50 is provided on the front surface of the fluorescent body 20 so that the diameter of a laser beam entering the fluorescent body 20 can be reduced, the size b3 of the fluorescent body 20 can be markedly reduced compared to that of the conventional technique (a5>b3). Thereby, the size of the entirety of the optical system can be reduced, thus making it possible to reduce the weight and production cost of the system and enhance the degree of freedom in design.

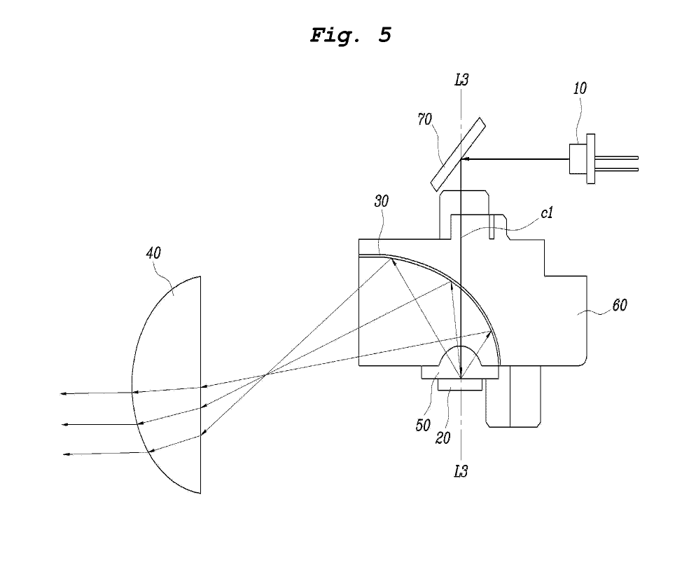

FIG. 5 shows a laser optical system for headlamps according to various other embodiments of the present invention. The laser optical system according to such embodiments includes: a laser diode 10 which generates a laser beam; a fluorescent body 20 which reacts to the laser beam and outputs white light; a main reflector 30 which reflects white light output from the fluorescent body 20 forward; an aspheric lens 40 which directs white light reflected by the main reflector 30 forward; a beam lens 50 which is disposed on a front surface of the fluorescent body 20, condenses or contracts a laser beam entering the fluorescent body 20, and reduces a radiation angle of white light output from the fluorescent body 20; and a beam reflector 70 which reflects a laser beam, output from the laser diode 10, towards the beam lens 50. A path cl of the laser beam that is reflected by the beam reflector 70 is aligned with a reference line L3 which is perpendicular to an incident surface of the fluorescent body 20 and passes through the center of the fluorescent body 20.

That is, the laser optical system shown in FIG. 5 has a configuration in which the beam reflector 70 is added to the laser optical system of FIGS. 3 and 4 and the path cl along which a laser beam reflected by the beam reflector 70 goes is aligned with the reference line L3. By virtue of such a configuration, the laser diode 10 can be disposed at a position other than the position at which the center axis of the laser diode 10 is aligned with the reference line L3. Thereby, the degree of freedom in design of the optical system can be further enhanced.

The constructions of the fluorescent body 20, the main reflector 30, the aspheric lens 40 and the beam lens 50 are the same as those of the laser optical system of FIGS. 3 and 4, and therefore further explanation will be omitted.

In this embodiment, the fluorescent body 20 and the beam lens 50 are disposed in a space defined by the main reflector 30, and the laser diode 10 and the beam reflector 70 are disposed outside the main reflector 30. Preferably, in some embodiments, the beam reflector 70 is fixed to the housing 60. As needed, a separate actuator may be used to adjust the orientation of the beam reflector 70.

To increase efficiency in reflecting a laser beam, a mirror may be used as the beam reflector 70. Alternatively, the beam reflector 70 may be configured in such a way that a reflective film is attached to one surface thereof

In some embodiments of the present invention, a laser optical system for headlamps may be configured such that it has the same or similar construction as that of FIG. 3 but does not have a beam lens 50. In other words, the laser optical system according to such embodiments includes: a laser diode 10 which generates a laser beam; a fluorescent body 20 which reacts to the laser beam and outputs white light; a main reflector 30 which reflects white light output from the fluorescent body 20 forward; and an aspheric lens 40 which is disposed ahead of the main reflector 30. The laser diode 10 is configured such that a center axis of the laser diode 10 is aligned with a reference line L3 which is perpendicular to an incident surface 21 of the fluorescent body 20 and passes through the center or the center portion of the fluorescent body 20.

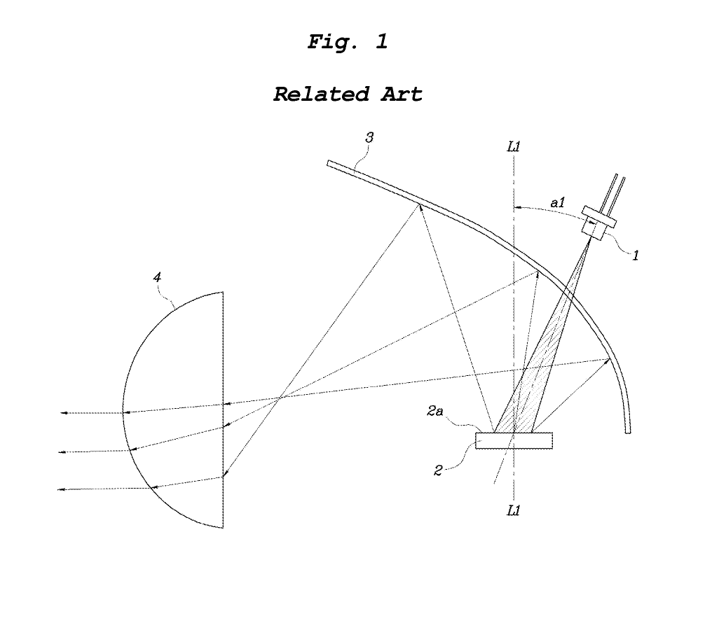

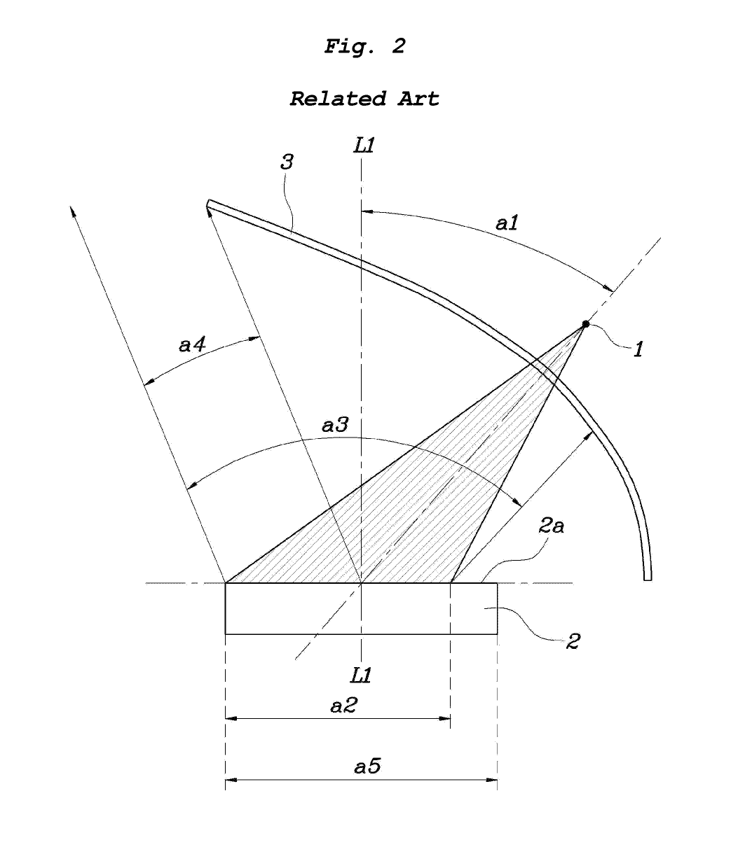

As described above, the laser optical system according to such embodiments has the same or similar construction as that of FIG. 3, except the beam lens 50, which condenses or contracts a laser beam output from the laser diode 10 and refracts the laser beam to enable it to enter the fluorescent body 20 and is able to reduce a radiation angle of white light output to the main reflector 30, has been removed. Even when the beam lens 50 is not present, because the laser diode 10 is configured such that the center axis of the laser diode 10 is aligned with the reference line L3, the advantages of the laser optical system according to the embodiment illustrated in FIGS. 3 and 4 can also be provided. In other words, compared to the conventional optical system shown in FIGS. 1 and 2, the optical system according to such embodiments can reduce not only the diameter of a laser beam entering the fluorescent body 20 but also an exit angle, that is, an effective radiation angle b1, of white light when the laser beam is output towards the main reflector 30 after exiting via the fluorescent body 20. Thereby, the optical loss of the entire optical system can be minimized, and the optical efficiency of the optical system can be markedly enhanced, in the same manner as that of the embodiment of FIGS. 3 and 4.

Furthermore, compared to the conventional optical system, the size b3 of the fluorescent body 20 can be markedly reduced. Therefore, the size, weight and production cost of the optical system can be reduced, and the degree of freedom in design thereof can be enhanced.

For convenience in explanation and accurate definition in the appended claims, the terms “inside” or “outside”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A laser optical system for headlamps, comprising:
a laser diode generating a laser beam;
a fluorescent body reacting to the laser beam and outputting white light;
a main reflector reflecting the white light output from the fluorescent body forward;
an aspheric lens directing the white light reflected by the main reflector forward; and
a beam lens provided on a front surface of the fluorescent body, the beam lens contracting the laser beam entering the fluorescent body and reducing a radiation angle of the white light output from the fluorescent body,
wherein the laser diode is configured such that a center axis of the laser diode is aligned with a reference line, the reference line being substantially perpendicular to an incident surface of the fluorescent body and passing through a center or a center portion of the fluorescent body.

2. The laser optical system as set forth in claim 1, wherein a diameter of the beam lens is greater than a diameter of the laser beam entering a lens surface of the beam lens and is less than a size of the main reflector.

3. The laser optical system as set forth in claim 1, wherein the fluorescent body and the beam lens are disposed in a space defined by the main reflector, and
the laser diode is disposed outside the main reflector.

4. The laser optical system as set forth in claim 1, wherein the beam lens comprises an aspheric lens or a convex lens.

5. A laser optical system for headlamps, comprising:
a laser diode generating a laser beam;
a fluorescent body reacting to the laser beam and outputting white light;
a main reflector reflecting the white light output from the fluorescent body forward;
an aspheric lens directing the white light reflected by the main reflector forward;
a beam lens provided on a front surface of the fluorescent body, the beam lens contracting the laser beam entering the fluorescent body and reducing a radiation angle of the white light output from the fluorescent body; and
a beam reflector reflecting the laser beam, output from the laser diode, towards the beam lens,
wherein a path of the laser beam reflected by the beam reflector is aligned with a reference line, the reference line being substantially perpendicular to an incident surface of the fluorescent body and passing through a center or a center portion of the fluorescent body.

6. The laser optical system as set forth in claim 5, wherein a diameter of the beam lens is greater than a diameter of the laser beam entering a lens surface of the beam lens and is less than a size of the main reflector.

7. The laser optical system as set forth in claim 5, wherein the fluorescent body and the beam lens are disposed in a space defined by the main reflector, and the laser diode and the beam reflector are disposed outside the main reflector.

8. The laser optical system as set forth in claim 5, wherein the beam lens comprises an aspheric lens or a convex lens.

9. The laser optical system as set forth in claim 5, wherein the beam reflector comprises a mirror.

10. A laser optical system for headlamps, comprising:
a laser diode generating a laser beam;
a fluorescent body reacting to the laser beam and outputting white light;
a main reflector reflecting the white light output from the fluorescent body forward; and
an aspheric lens directing the white light reflected by the main reflector forward,
wherein the laser diode is configured such that a center axis of the laser diode is aligned with a reference line, the reference line being substantially perpendicular to an incident surface of the fluorescent body and passing through a center or a center portion of the fluorescent body.

11. The laser optical system as set forth in claim 10, wherein a diameter of the beam lens is greater than a diameter of the laser beam entering a lens surface of the beam lens and is less than a size of the main reflector.

12. The laser optical system as set forth in claim 11, wherein the fluorescent body and the beam lens are disposed in a space defined by the main reflector, and the laser diode is disposed outside the main reflector.

13. The laser optical system as set forth in claim 11, wherein the beam lens comprises an aspheric lens or a convex lens.
